(19) United States
(12) Patent Application Publication
(10) Pub. No.: US 2016/0072744 A1
(43) Pub. Date: Mar. 10, 2016

(54) AUTOMATIC SHARING OF MESSAGE ATTACHMENTS ACROSS MULTIPLE SYSTEMS

(71) Applicant: International Business Machines Corporation, Armonk, NY (US)

(72) Inventors: Joseph Kubik, Cary, NC (US); David M. Wendt, Cary, NC (US)

(21) Appl. No.: 14/482,300

(22) Filed: Sep. 10, 2014

(51) Int. Cl. H04L 12/58

(52) U.S. Cl. CPC H04L 51/08

(57) ABSTRACT

Provided are techniques for automatic sharing of message attachments across multiple systems. A message that identifies message recipients by their target addresses and includes an attachment is received. Each of the target addresses is mapped to one or more common file servers. It is determined which of the one or more common file servers is to be used for each of the message recipients by grouping message recipients that use a same common file server. For each of the grouped message recipients, a modified message is created by creating copy of the message that adds an attachment link for use in accessing the attachment from the same common file server.

### FIELD

Embodiments of the invention relate to automatic sharing of message attachments across multiple systems.

### BACKGROUND

Today, sending files is often done using electronic mail (“email” or “e-mail”). An email message is written about the content of one or more files and the one or more files are attached to the email message and sent via email. When sending the email message to multiple people, the electronic mail system generates a copy of the email message, including the one or more attachments, for each email recipient. This means that sending an email message to 10 people with a one attachment will result in 10 copies of that attachment, especially if each copy of the email message is sent to different electronic mail servers or different electronic mail domains.

An alternate technique involves storing the file on a central server (i.e., uploading the file to the central server) accessible by the email recipients in the email list and then including a link to the file in the copy of the email message, instead of attaching the file itself Many file-management solutions provide this kind of feature to save mail storage, network bandwidth, etc.

Unfortunately, storing the file on the central server requires that email recipients all have access to that central server or at least to the file in that central server. This may not be desirable or even possible in certain cases. For example, if the central server is an internal server, it is not possible to send a link to that file to an external party. An example scenario is a law firm that needs to send a file to a client, as well as, copy one or more internal people. The file may be available on a central server internally, but the client will not be able to download the file from the central server. Automatically granting access to the mail email recipients is challenging in that it would require registering a mail email recipient by creating a username and password on their behalf This would require sending a separate email to each new user with details on how to retrieve their authentication credentials since the authentication credentials could not be directly sent for security reasons.

This scenario has become more common with broader customer adoption of existing cloud-based storage systems.

### SUMMARY

Provided is a method for automatic sharing of message attachments across multiple systems. The method comprises: receiving, with a processor of a computer, a message that identifies message recipients by their target addresses and includes an attachment; mapping each of the target addresses to one or more common file servers;

determining which of the one or more common file servers is to be used for each of the message recipients by grouping message recipients that use a same common file server; and, for each of the grouped message recipients, creating a modified message by creating copy of the message that adds an attachment link for use in accessing the attachment from the same common file server.

Provided is a computer program product for automatic sharing of message attachments across multiple systems. The computer program product comprises a computer readable storage medium having program code embodied therewith, the program code executable by at least one processor to perform: receiving, by the at least one processor, a message that identifies message recipients by their target addresses and includes an attachment; mapping, by the at least one processor, each of the target addresses to one or more common file servers; determining, by the at least one processor, which of the one or more common file servers is to be used for each of the message recipients by grouping message recipients that use a same common file server; and, for each of the grouped message recipients, creating, by the at least one processor, a modified message by creating copy of the message that adds an attachment link for use in accessing the attachment from the same common file server.

Provided is a computer system for automatic sharing of message attachments across multiple systems. The computer system comprises: one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform operations, the operations comprising: receiving a message that identifies message recipients by their target addresses and includes an attachment; mapping each of the target addresses to one or more common file servers; determining which of the one or more common file servers is to be used for each of the message recipients by grouping message recipients that use a same common file server; and, for each of the grouped message recipients, creating a modified message by creating copy of the message that adds an attachment link for use in accessing the attachment from the same common file server.

### BRIEF DESCRIPTION OF THE SEVERAL VIEWS OF THE DRAWINGS

In the drawings, like reference numbers represent corresponding parts throughout.

FIG. 1 illustrates, in a block diagram, a computing environment in accordance with certain embodiments.

FIG. 2 illustrates an example of a modified email message in accordance with certain embodiments.

FIG. 3 illustrates an example address book in accordance with certain embodiments.

FIG. 4 illustrates redirection when a message recipient selects an attachment link in accordance with certain embodiments.

FIG. 5 illustrates an example list of attachments in accordance with certain embodiments.

FIG. 6 illustrates, in a flow diagram, operations for processing a message before the message is sent to message recipients in accordance with certain embodiments.

FIG. 7 illustrates, in a flow diagram, operations for processing a message when a message recipient selects an attachment link in accordance with certain embodiments.

FIG. 8 illustrates, in a block diagram, a computer architecture that may be used in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

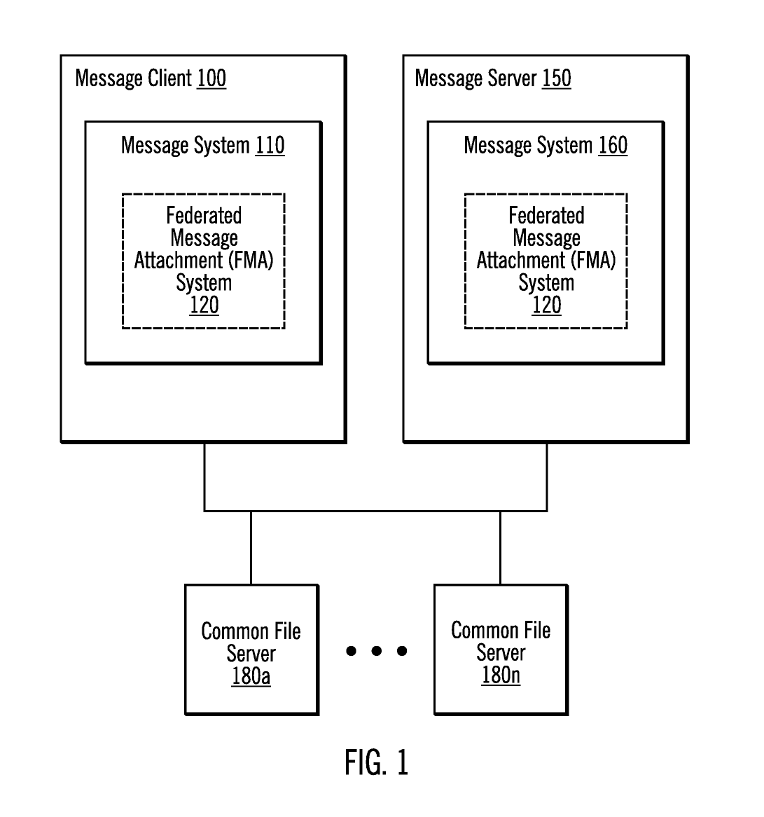

FIG. 1 illustrates, in a block diagram, a computing environment in accordance with certain embodiments. A message client 100 and a message server 150 are coupled to each other and to multiple common file servers 180a . . . 180n (where the ellipses indicate that there may be other central file systems). The common file servers 180a . . . 180n may also be referred to as “place destinations”. In certain embodiments, the message client 100 includes a message system 110, and the message system 110 includes a Federated Message Attachment (FMA) system 120. In certain embodiments, the mail server 150 includes a message system 160, and the message system 160 includes the FMA system 120. In certain embodiments, both the message client and the message server include the FMA system 120.

Given a message with attachments, the FMA system 120 analyzes the message recipients, identifies multiple common file servers 180a . . . 180n so that each of the message recipients has access to at least one of these identified common file servers 180a . . . 180n, and copies the attachments to the common file servers 180a . . . 180n. The FMA system 120 modifies the message before the message is sent to the message recipients to include an attachment link to the FMA system 120, which then provides each message recipient access to the attachments from their common file server 180a . . . 180n. In certain embodiments, the attachment link is a Uniform Resource Locator (URL). The attachment link may be described as being associated with or pointing to an attachment.

In various embodiments, the message may be an electronic mail message with attachments, a chat message in which attachments may be exchanged, a multi-media text message in which images/videos are treated as attachments by the underlying system, or other types of messages. Merely to enhance understanding of embodiments, some examples are provided herein with reference to email messages.

In various embodiments, the attachments may be documents, spreadsheets, images, or other types of content.

If all the message recipients share access to a common file server 180a . . . 180n, then only one copy of the attachments is required. Otherwise, copies of the attachments are made for each common file server 180a . . . 180n as resolved by the message recipient list. The message recipient list is analyzed before the email message leaves the sender (e.g., using a custom message client or a message client plugin).

With this approach, discussions around the attachment may be more easily moved from email into a collaboration system. This especially true if all message recipients share a common file server 180a . . . 180n. In addition, with this approach, there is reduced email traffic since the attachments are copied only when necessary and do not exceed the number of message recipients.

When a user receives the email message, the attachment link will take the user to the FMA system 120, which provides the user with access to the attachments from the appropriate common file server 180a . . . 180n. The FMA system 120 may either redirect the user to the corresponding common file server 180a . . . 180n or become a proxy for downloading or viewing the attachments. Thus, in certain embodiments, the FMA system 120 acts as a proxy as an intermediate server that routes requests from the user (via the received email message) to the common file server 180a . . . 180n containing the attachments.

In certain embodiments, the message client 100 and/or the message server 150 is configured with the FMA system 120 for the sender. This configuration may include common file server 180a . . . 180n and authentication credentials (e.g., user_identifier/password for that common file server 180a . . . 180n). and an address book that maps email addresses to common file servers (e.g., a cloud system). In certain embodiments, a system administrator configures the address book to include the common file server 180a . . . 180n to be used for each message recipient. In certain embodiments, a sender configures the address book to include the common file server 180a . . . 180n to be used for each message recipient.

When the sender sends the email message (e.g., hits the send button), the target email addresses and the attachments are uploaded to the FMA system 120, which copies the attachments and a Globally Unique Identifier (GUID) (e.g., the message recipient's email address) to the appropriate common file server. At the message client 100, either the FMA system 120 or the message client 100 removes the attachments from the email message, includes a unique message-specific attachment link to the FMA system 120 in the email message, and sends the email message.

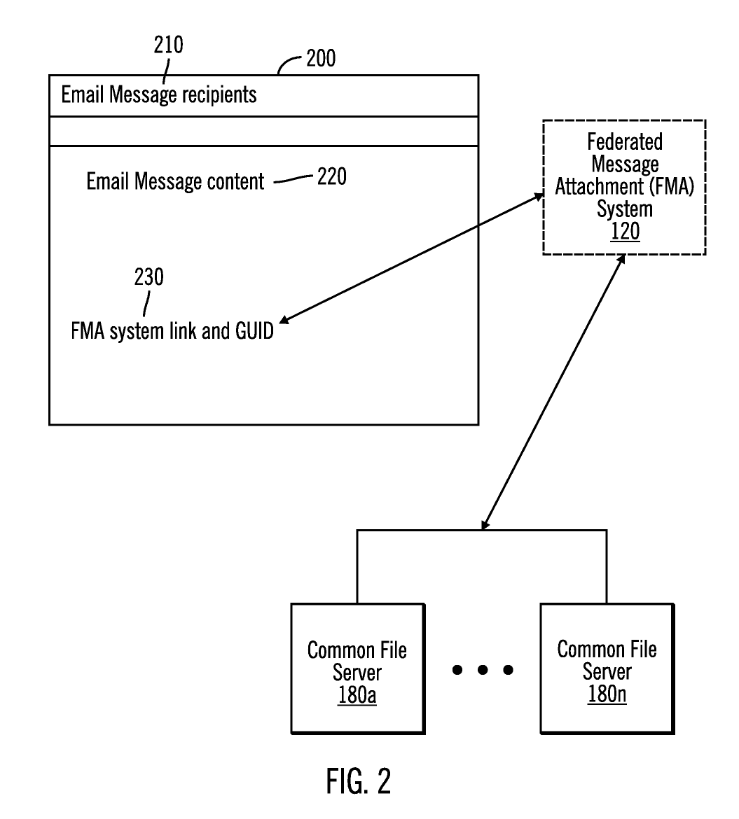

FIG. 2 illustrates an example of a modified email message 200 in accordance with certain embodiments. The email message 200 has a list of email message recipients 210, email message content 220, and added information 230 that provides an attachment link to the FMA system 120 and a GUID. The FMA system 120 adds the information 230. When a message recipient selects (e.g., clicks on) the attachment link, the FMA system 120 may use the GUID and/or other information to identify a common file server 180a . . . 180n storing one or more attachments for the message recipient, to retrieve the one or more attachments, and to return the one or more attachments to the message recipient. Thus, in certain embodiments, an attachment is associated with an attachment link and a GUID, and the GUID is associated with a common file server 180a . . . 180n that is storing the attachment.

In certain embodiments, if the FMA system 120 is not able to identify a common fil server for a message recipient, then, the FMA system 120 or the message client 100 may prompt the message recipient or sender to resolve this before completing the send. In certain embodiments, a default location may be specified by the sender and may require the message recipient to sign up to retrieve the attachments. With a default location configured, embodiments may execute on the mail server 150 instead of or in addition to the message client 100.

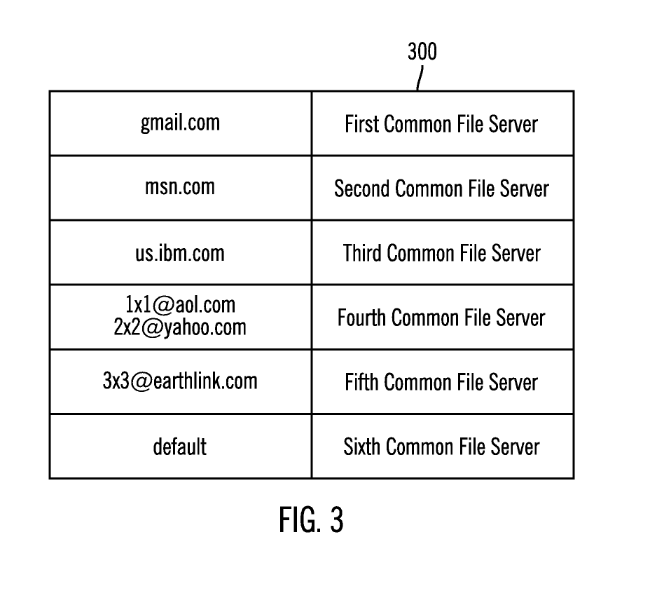

FIG. 3 illustrates an example address book 300 in accordance with certain embodiments. In the address book, there are different common file servers identified for different email addresses.

In certain embodiments, when a message recipient selects the attachment link in the email message, a browser is launched and shows an FMA system page that verifies the message recipient. With embodiments, the message recipient uses his or her own authentication credentials (e.g., username and password) to log in to the common file system. With such embodiments, the browser is then redirected to a User Interface (UI) for the common file server 180a . . . 180n storing the attachments or to a custom UI provided by the FMA system 120. The UI enables the message recipient to download the attachments through the FMA system 120.

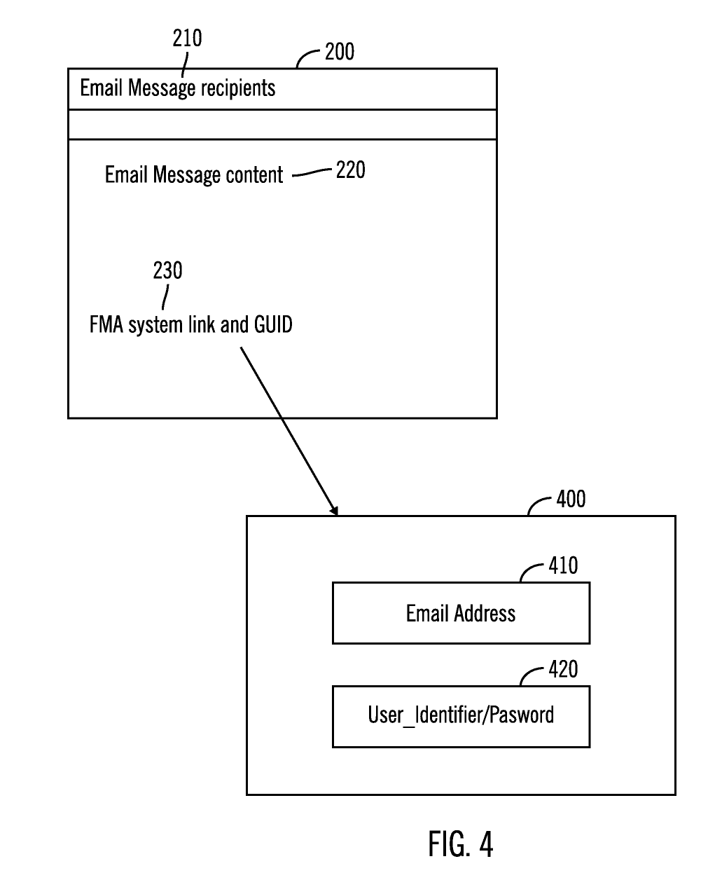

FIG. 4 illustrates redirection when a message recipient selects an attachment link in accordance with certain embodiments. In FIG. 4, when a user selects the attachment link in the additional information 230, the FMA system 120 launches a browser 400. The browser 400 verifies the message recipient by requesting, for example, an email address 410 and/or a user_identifier/password 420. For example, the GUID from the message, which may be an email address, may be matched to an email address provided by the user. In certain embodiments, once the user is verified, the browser 400 displays the attachments. In certain embodiments, if there is one attachment, optionally a download may be automatically triggered for that one attachment.

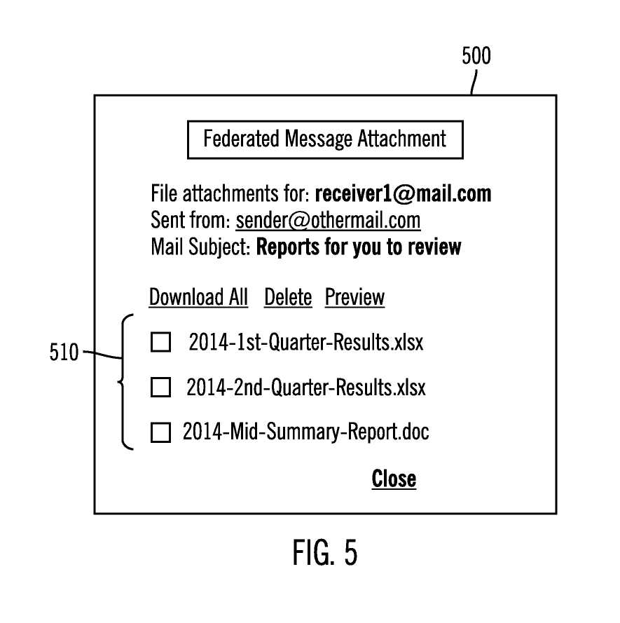

FIG. 5 illustrates a list of attachments 510 in accordance with certain embodiments. In particular, once a user is verified (using browser 400), the browser is then redirected to a User Interface (UI) for the common file server 180a . . . 180n storing the attachments or to a custom UI provided by the FMA system 120, such as UI 500. UI 500 provides a list of attachments 510, and a user may select one or more of these for download from the common file server to another computing device.

In certain embodiments, included in the original mail message, along with the attachment link, is a specially formatted GUID that may be used by the message client plugin or by the mail server to re-process the message through the FMA system 120. For example, any new message recipients may be resolved and the attachments copied as needed just as in the new message case. This extra GUID, as well as the attachment link, is part of the message so forwarding from any user may utilize the FMA system 120. Also, the GUID may be included in a custom mail header since mail servers tend to forward these without interpretation.

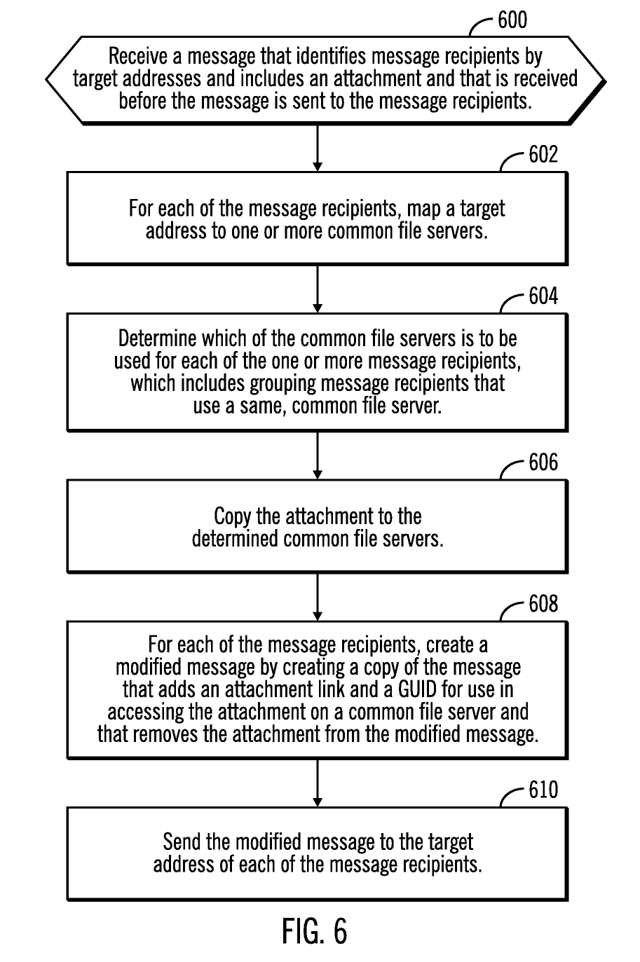

FIG. 6 illustrates, in a flow diagram, operations for processing a message before the message is sent to message recipients in accordance with certain embodiments. Control begins at block 600 with the FMA system 120 receiving a message that identifies message recipients by target addresses (e.g., email addresses) and includes an attachment and that is received before the message is sent to the message recipients. For each of the message recipients, in block 602, the FMA system 120 maps a target address to one or more common file servers. For example, with embodiments, one email address may be associated with multiple common file servers. In block 604, the FMA system 120 determines which of the common file servers is to be used for each of the one or more message recipients, which includes grouping message recipients that use a same, common file server. For example, if a first message recipient's target address maps to common file server A and common file server B, and a second message recipient's target address maps to common file server B, then the FMA system 120 determines that the common file server B should be used for the first message recipient and the second message recipient to minimize copies of the attachment.

In block 606, the FMA system 120 copies the attachment to the determined common file servers. For each of the message recipients, in block 608, the FMA system 120 creates a modified message by creating a copy of the message that adds an attachment link and a GUID for use in accessing the attachment on a common file server and that removes the attachment from the modified message. In block 610, the FMA system 120 sends the modified message to the target address of each of the message recipients.

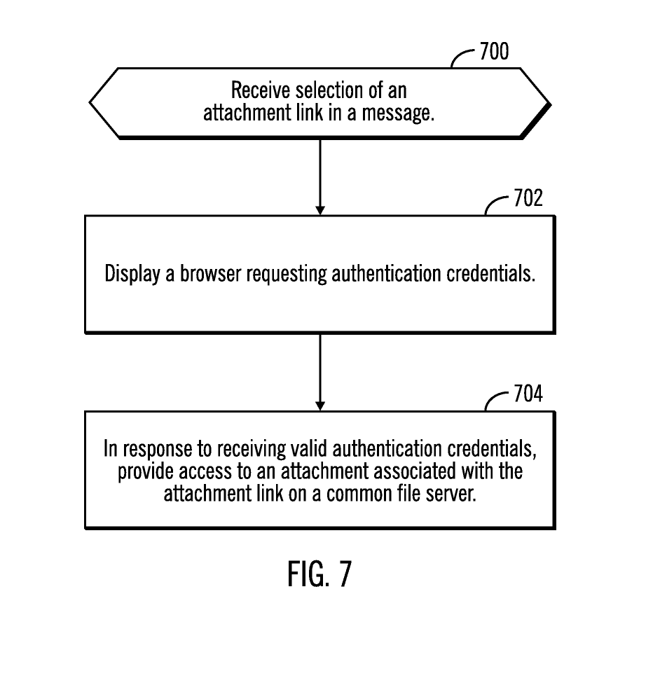

FIG. 7 illustrates, in a flow diagram, operations for processing a message when a message recipient selects an attachment link in accordance with certain embodiments. Control begins at block 700 with the FMA system 120 receiving selection of an attachment link in a message. In block 702, in response to receiving the selection of the attachment link, the FMA system 120 displays a browser requesting authentication credentials. In response to receiving valid authentication credentials, in block 704, the FMA system 120 provides access to an attachment associated with (or pointed to by) the attachment link on a common file server. In embodiments, access to the attachment is not provided if the authentication credentials are not valid.

Thus, embodiments enable the use of multiple common file servers for storage of the attachments, based on particularities of each message recipient (e.g., internal common file server vs. external common file server). Also, embodiments provide the FMA system 120 to allow message recipients to receive the same email message content, but with potentially different attachment links, independent of the number of different common file servers that may be used to store the attachments to the email message. Embodiments allow management and sharing of attachments that does not require message recipients to be registered on the same common file server 180a . . . 180n in order to receive the attachments.

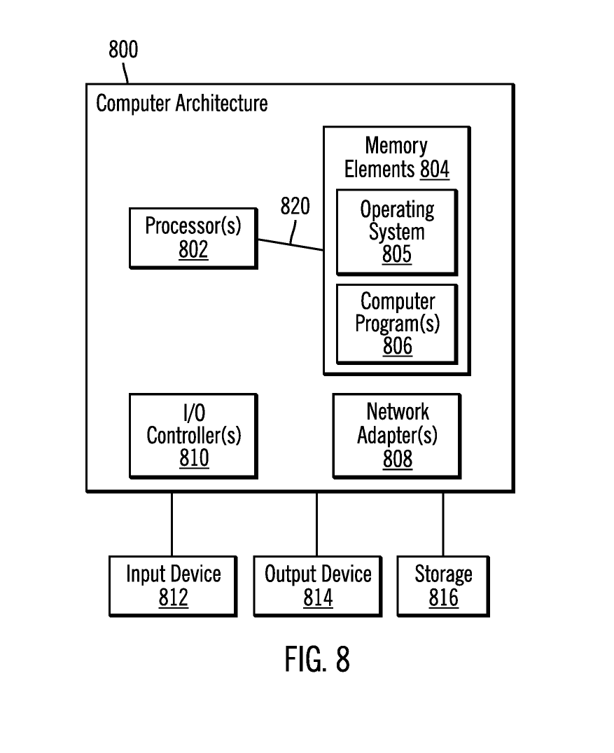

FIG. 8 illustrates a computer architecture 800 that may be used in accordance with certain embodiments. In certain embodiments, message client 100 and/or message server 150 may implement computer architecture 800. The computer architecture 800 is suitable for storing and/or executing program code and includes at least one processor 802 coupled directly or indirectly to memory elements 804 through a system bus 820. The memory elements 804 may include local memory employed during actual execution of the program code, bulk storage, and cache memories which provide temporary storage of at least some program code in order to reduce the number of times code must be retrieved from bulk storage during execution. The memory elements 804 include an operating system 805 and one or more computer programs 806.

Input/Output (I/O) devices 812, 814 (including but not limited to keyboards, displays, pointing devices, etc.) may be coupled to the system either directly or through intervening I/O controllers 810.

Network adapters 808 may also be coupled to the system to enable the data processing system to become coupled to other data processing systems or remote printers or storage devices through intervening private or public networks. Modems, cable modem and Ethernet cards are just a few of the currently available types of network adapters 808.

The computer architecture 800 may be coupled to storage 816 (e.g., any type of storage device; a non-volatile storage area, such as magnetic disk drives, optical disk drives, a tape drive, etc.). The storage 816 may comprise an internal storage device or an attached or network accessible storage. Computer programs 806 in storage 816 may be loaded into the memory elements 804 and executed by a processor 802 in a manner known in the art.

The computer architecture 800 may include fewer components than illustrated, additional components not illustrated herein, or some combination of the components illustrated and additional components. The computer architecture 800 may comprise any computing device known in the art, such as a mainframe, server, personal computer, workstation, laptop, handheld computer, telephony device, network appliance, virtualization device, storage controller, etc.

### Additional Embodiment Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1-6. (canceled)

7. A computer program product, the computer program product comprising a computer readable storage medium having program code embodied therewith, the program code executable by at least one processor to perform:
receiving, by the at least one processor, a message that identifies message recipients by their target addresses and includes an attachment;
mapping, by the at least one processor, each of the target addresses to one or more common file servers;
determining, by the at least one processor, which of the one or more common file servers is to be used for each of the message recipients by grouping message recipients that use a same common file server; and
for each of the grouped message recipients, creating, by the at least one processor, a modified message by creating copy of the message that adds an attachment link for use in accessing the attachment from the same common file server.

8. The computer program product of claim 7, wherein the modified message includes a Globally Unique Identifier (GUID) that is used to identify a message recipient from the message recipients.

9. The computer program product of claim 7, the computer program product comprising the computer readable storage medium having program code embodied therewith, the program code executable by the at least one processor to perform:
in response to determining that one of the target addresses does not map to one of the one or more common file servers, requesting, by the at least one processor, a common file server.

10. The computer program product of claim 7, the computer program product comprising the computer readable storage medium having program code embodied therewith, the program code executable by the at least one processor to perform:
in response to determining that a particular target address of the target addresses does not map to one of the one or more common file servers, mapping, by the at least one processor, the particular target address to a default common file server.

11. The computer program product of claim 7, the computer program product comprising the computer readable storage medium having program code embodied therewith, the program code executable by the at least one processor to perform:
upon selection of the attachment link and in response to receiving valid authentication credentials, providing, by the at least one processor, access to the attachment associated with the attachment link.

12. The computer program product of claim 7, wherein one of the one or more common file servers is an internal common file server and another of the one or more common file servers is an external common file server.

13. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more memories, to perform operations, the operations comprising:
receiving a message that identifies message recipients by their target addresses and includes an attachment;
mapping each of the target addresses to one or more common file servers;
determining which of the one or more common file servers is to be used for each of the message recipients by grouping message recipients that use a same common file server; and
for each of the grouped message recipients, creating a modified message by creating copy of the message that adds an attachment link for use in accessing the attachment from the same common file server.

14. The computer system of claim 13, wherein the modified message includes a Globally Unique Identifier (GUID) that is used to identify a message recipient from the message recipients.

15. The computer system of claim 13, wherein the operations further comprise:
in response to determining that one of the target addresses does not map to one of the one or more common file servers, requesting a common file server.

16. The computer system of claim 13, wherein the operations further comprise:
in response to determining that a particular target address of the target addresses does not map to one of the one or more common file servers, mapping the particular target address to a default common file server.

17. The computer system of claim 13, wherein the operations further comprise:
upon selection of the attachment link and in response to receiving valid authentication credentials, providing access to the attachment associated with the attachment link.

18. The computer system of claim 13, wherein one of the one or more common file servers is an internal common file server and another of the one or more common file servers is an external common file server.
